(19) United States
(12) Patent Application Publication
(10) Pub. No.: US 2015/0339613 A1
(43) Pub. Date: Nov. 26, 2015

(54) Managing developer productivity

(71) Applicant: Virtusa Corporation, Westborough, MA (US)

(72) Inventor: Chandika Nalin Mendis, Rajagiriya (LK)

(21) Appl. No.: 14/720,693

(22) Filed: May 22, 2015

Related U.S. Application Data
(60) Provisional application No. 62/002,161, filed on May 22, 2014.

(51) Int. Cl. G06Q 10/06; G06F 9/44

(52) U.S. Cl. CPC G06Q 10/06393; G06Q 10/067; G06F 8/70

(57) ABSTRACT

Automated generation of a unified sizing and estimation model across multiple technologies that provides insight at the project level, the release level, and the individual level using crowd sourced and real-time intelligence.

### CROSS-REFERENCE TO RELATED APPLICATIONS

This application claims priority to and the benefit of U.S. Provisional Patent Application Ser. No. 62/002,161, filed May 22, 2014, which is incorporated herein by reference as if set forth in its entirety.

### FIELD

Embodiments of the invention generally relate to managing developer productivity, and in particular to the use of a multi-technology sizing and estimation model to evaluate individual programmer contributions.

### BACKGROUND

It is a common management adage that measurement is a prerequisite to effective management. The effective management of programmers requires measurements of their productivity and effort spent developing software. These measurements in turn require accurate estimates of the effective size of their contributions. However, existing measurement methodologies suffer from various deficiencies.

Existing methodologies typically are variations on one or both of two techniques: (1) lines of code (hereinafter “LOC”) measures; and (2) function point analysis.

LOC measures simply count the number of lines of text of a program's source code. LOC measures are simple to understand, easy to compare, and easy to collect. Cost and benefit are determined by simply calculating the dollar cost per line of code. However, while effort may be highly correlated with LOC measures, the amount of functionality of the software is not necessarily heavily correlated to LOC.

Moreover, effort is less correlated with LOC measures since the advent of so called “high-level” programming languages that may require extensive pre-programming activities such as drafting requirements and design diagrams. In that case, LOC could drastically underestimate the effort required to code software. Thus, LOC measures may provide an adequate measure of an individual programmer's raw output, but fail to capture the quantum of system functionality delivered. Moreover, LOC can be manipulated through unnecessary duplication of effort, less reuse of code, etc.

Function point analysis (FP) measures the amount of functionality the software provides a user. For example, function point analysis awards more points to a program that provides a user the capability to perform ten essential business tasks than to a program that provides a user the capability to perform only four similarly essential business tasks. Different tasks may be scored differently based on metrics such as type and complexity.

However, FP analysis is complex and requires extensive training and experience for effective implementation. FP analysis by itself does not necessarily provide a measure of how much effort went into developing the software. Further, FP analysis may include some significant element of subjectivity. FP is also poorly suited to measuring development done using packaged software such as Pega, Sharepoint or SAP; for this reason such platforms often offer their own custom effort estimation mechanisms.

Functional sizing methods typically assess contributions at an application level or at a particular release level, not at the level of an individual developer. Moreover, these methods typically assume a “size-to-effort” factor based on past experience with similar technologies. Applying such methods to enterprise-level projects can be problematic, as such projects typically leverage multiple technologies. Approaches that account for past organizational data exist, but they require so much effort that most organizations fail to use these approaches as they are intended.

Due to differences in sizing and estimation models adapted to different work types (e.g., FP for Java and DCO for Pega), as well as differences in size-to-effort values based on various technology related factors, there is no effective method to compare productivity across development teams or developers doing different types of work.

Accordingly, there is a need for methods and systems that accurately evaluate the contributions of individual programmers utilizing different technologies.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

Various embodiments of the present invention provide a unified sizing and estimation model across multiple technologies that provide insight at the project level, the release level, and the individual level using crowd sourced and real-time intelligence.

In one aspect, embodiments of the present invention provide a method for productivity measurement. The method includes executing the following steps by at least one processor capable of executing instructions encoded on a computer-readable medium: decomposing requirements into a plurality of tasks; assigning each of the plurality of tasks to an individual for execution; collecting a size value and an effort value associated with the execution of each task; and creating a parametric model from a plurality of size values and effort values. Each task is selected from a group consisting of previously-defined work types that are associated with an implementing technology.

In one embodiment, the method further includes utilizing the parametric model to create an estimated effort value for a task associated with the implementing technology associated with the parametric model. In one embodiment, the requirements are associated with a plurality of implementing technologies.

In one embodiment, the method further comprises associating each of the plurality of tasks with a sizing method. In one embodiment, the sizing methods are selected from the group consisting of functionality, schema, and configuration. In one embodiment, the sizing method is a continuous function.

In one embodiment, creating a parametric model comprises performing a regression fit to the parametric model. In one embodiment, the plurality of size values and effort values used for the creation of the parametric model are associated with one of an individual developer, a plurality of developers, and a development organization.

In one embodiment, the method further includes computing expected effort utilizing the created parametric model. In one embodiment, the method further includes evaluating performance using the created parametric model.

In another aspect, embodiments of the present invention provide a computer program product for enabling a computer to manage productivity. The product includes a non-transitory computer readable medium and software instructions encoded on the non-transitory computer readable medium that when executed enable the computer to perform the operations of: decomposing requirements into a plurality of tasks; assigning each of the plurality of tasks to an individual for execution; collecting a size value and an effort value associated with the execution of each task; and creating a parametric model from a plurality of size values and effort values. Each task is selected from a group consisting of previously-defined work types that are associated with an implementing technology.

In one embodiment, the software instructions further include the operation of utilizing the parametric model to create an estimated effort value for a task associated with the implementing technology associated with the parametric model. In one embodiment, the requirements are associated with a plurality of implementing technologies.

In one embodiment, the software instructions further include the operation of associating each of the plurality of tasks with a sizing method. In one embodiment, the sizing methods are selected from the group consisting of functionality, schema, and configuration. In one embodiment, the sizing method is a continuous function.

In one embodiment, the software instructions for creating a parametric model comprises include software instructions for performing a regression fit to the parametric model. In one embodiment, the plurality of size values and effort values used for the creation of the parametric model are associated with one of an individual developer, a plurality of developers, and a development organization.

In one embodiment, the software instructions further include the operation of computing expected effort utilizing the created parametric model. In one embodiment, the software instructions further include the operation of evaluating performance using the created parametric model.

These and other features and advantages, which characterize the present non-limiting embodiments, will be apparent from a reading of the following detailed description and a review of the associated drawings. It is to be understood that both the foregoing general description and the following detailed description are explanatory only and are not restrictive of the non-limiting embodiments as claimed.

### BRIEF DESCRIPTION OF DRAWINGS

Non-limiting and non-exhaustive embodiments are described with reference to the following figures in which:

FIG. 1 is a flowchart of a method for managing productivity in accord with an embodiment of the present invention;

FIG. 2 presents an example of a user interface for creating and managing requirements in accord with the present invention;

FIG. 3 presents an example of decomposing requirements into work items and assigning those work items to individuals in accord with the present invention;

FIG. 4A presents an example of sizing schema-type work items in accord with the present invention;

FIG. 4B presents an example of sizing configuration-type work items in accord with the present invention;

FIG. 4C presents an example of sizing functionality-type work items in accord with the present invention; and

FIG. 5 presents a block diagram of an exemplary apparatus for productivity management in accord with an embodiment of the present invention.

In the drawings, like reference characters generally refer to corresponding parts throughout the different views. The drawings are not necessarily to scale, emphasis instead being placed on the principles and concepts of operation.

### DETAILED DESCRIPTION

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are the means used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions that could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The processes and displays presented herein are not inherently related to any particular computer or other apparatus. Various general purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

Embodiments of the present invention provide a unified sizing and estimation model applicable across multiple technologies that provide insight at the project level, the release level, and the individual level using crowd sourced and real-time intelligence.

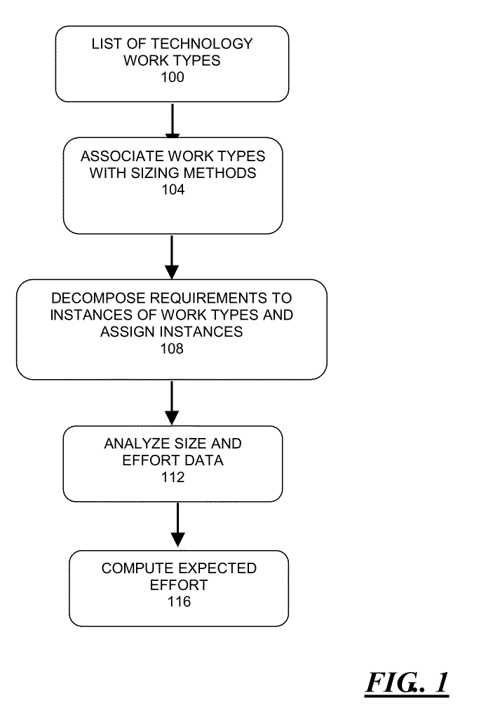

As illustrated in FIG. 1, certain embodiments of the present invention begin the evaluation process by defining or receiving one or more lists of work types, each list associated with a particular technology such as Pega, Java, C++, etc. (Step 100). Each list of work types provides a set of elements that can be used for the systematic decomposition of any requirement in that technology into sizeable and logically identifiable chunks of work that can be assigned to individual developers. Worktypes for a technology are typically defined in advance by Subject Matter Experts (SMEs) familiar with that technology as well as being defined by the standard sizing methods, although it may also be automated in certain embodiments. By providing pre-defined lists of work types for each development technology, the system also helps bridge the gap between project management and technology and standardizes work allocation.

For example, development projects in Pega can be associated with a list of work types such as “atomic use case,” “report,” “correspondence,” “business rule,” “interface,” etc., each of which match the definitions in the Pega DCO estimation template. The use of development units that are native to the development technology results in assignments that are more developer-friendly than development units derived from concepts specific to the sizing model, such as “data functions” or “transaction functions” in FP. Similarly, development projects in Java may be associated with a list of work types such as “User Interface,” “Middle Tier Business Logic,” “Database Schema,” “Data Access,” etc.

Next, each of the work types in the list(s) is associated with a sizing method (Step 104). This mapping is also typically done in advance by a Subject Matter Expert, although it may also be automated in certain embodiments. Three examples of sizing methods that are typically associated with individual work types include functionality sizing, schema sizing, and configuration sizing, each of which is discussed in greater detail below. These three sizing methods apply to most forms of development work, including ground-up development as well as package development and configuration-based development. These sizing methods can be used for new projects as well as projects that constitute modifications and enhancements to existing software.

The various assigned sizing methods accept various values as inputs and emit as an output an estimate of size. Some of the assigned sizing methods have a continuous/smooth sizing curve based on the source inputs. Other assigned sizing methods utilize High-Medium-Low sizing slabs that are common in most industry standard sizing methods (e.g., both FP and Pega DCO have this type of size or effort slabs).

For example, schema sizing receives as inputs the number of data groups and the number of data columns impacted by the work and provides a single output of size. IFPUG Function Points provides a 3×3 reference matrix to calculate FP size based on the number of data groups and data columns. The continuous curve mentioned above considers the sensitivity of the output size to the two parameters “data groups” and “data columns”. The exact mechanism for determining this formula could vary. For example, a statistical method could be used to calculate these factors based on the correlation of average efforts taken from empirical data based on these two parameters or derived using the factors in the 3×3 FP reference matrix mentioned above.

The functional sizing method uses Cosmic FFP as a basis and takes as input the number of data movements impacted by the functionality. Data movements are the number of data groups that enter or exit from the front-end of the functional scope being measured, as well as the number of data groups read-from or written-to the backend of that scope. In the functional sizing method, the size emitted is the same as the number of data movements that are counted.

The configuration sizing method receives as input the number of configuration elements. The size emitted is the same as the number of configuration elements.

Thus, in contrast to IFPUG Function Points or Pega DCO, each of which use slabs of H/M/L-type categorization for size determination, embodiments of the present invention use a smooth sizing function for each of the sizing categories. By doing this, the system uniquely scales industry best practices down to the smaller scale required to measure individual developer contributions.

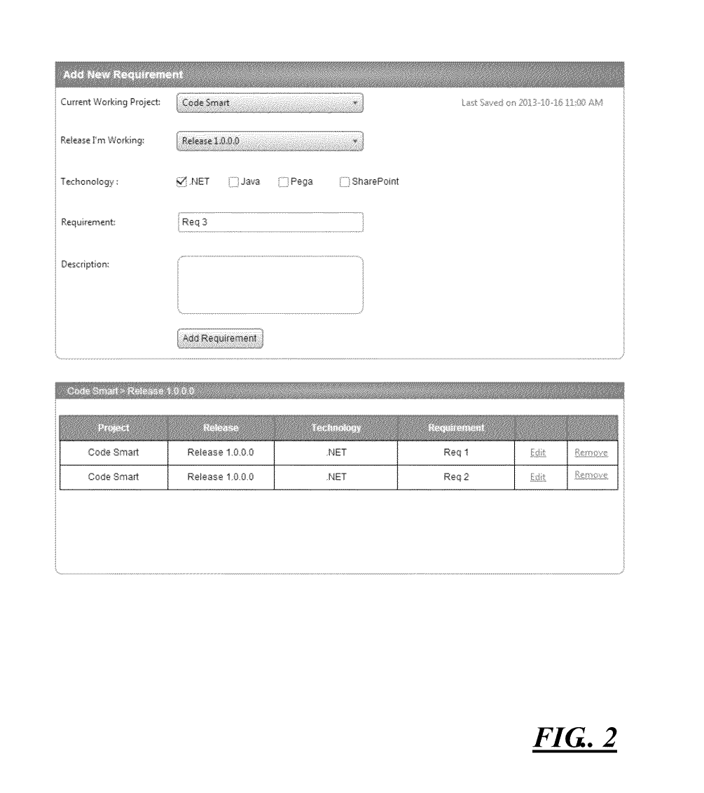

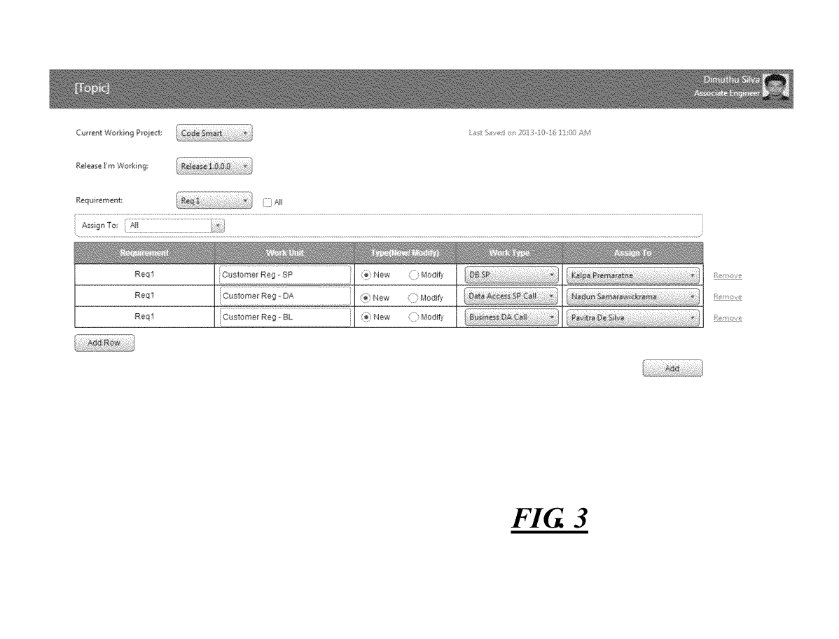

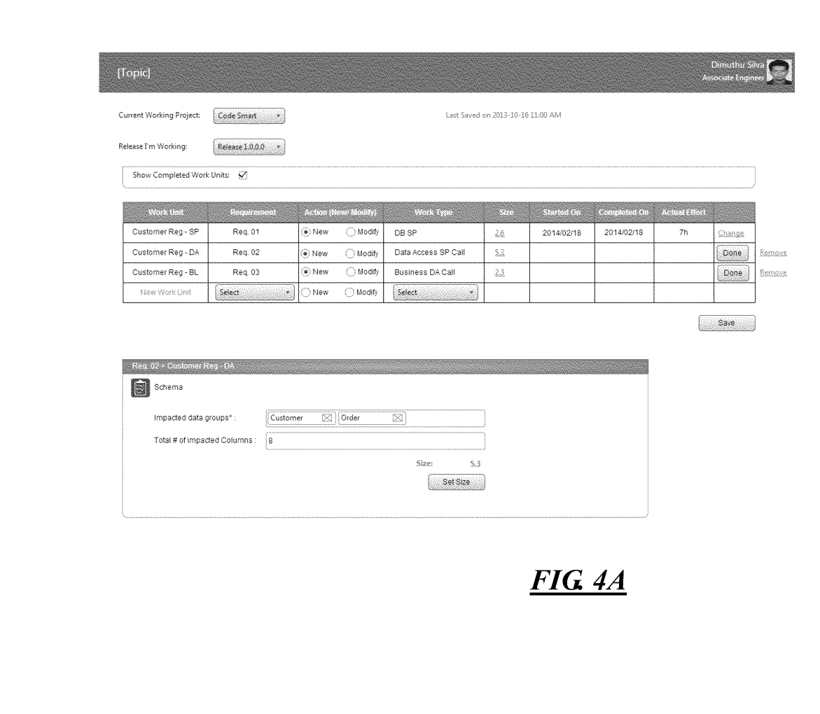

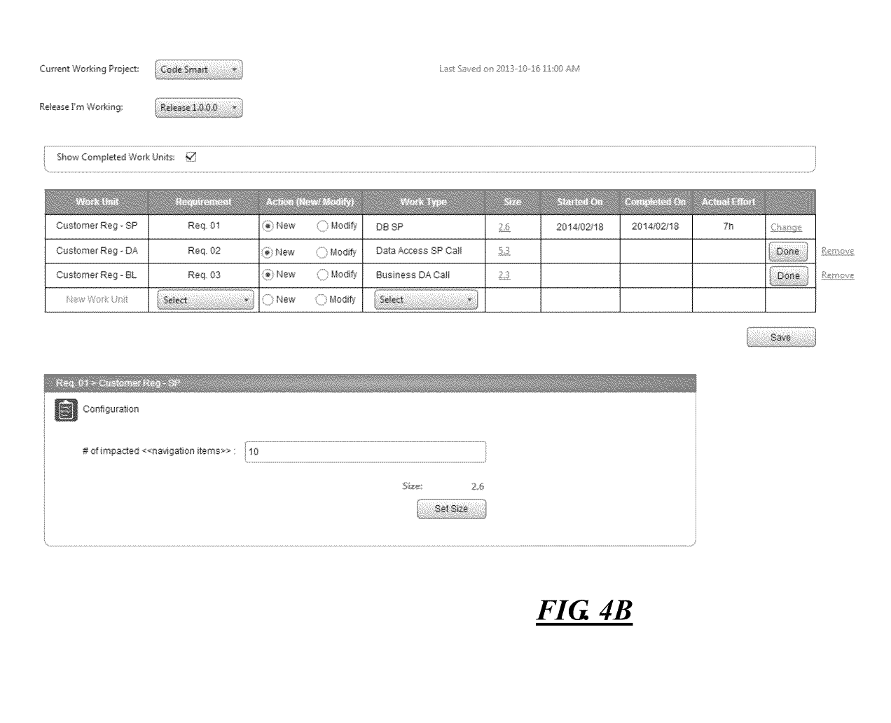

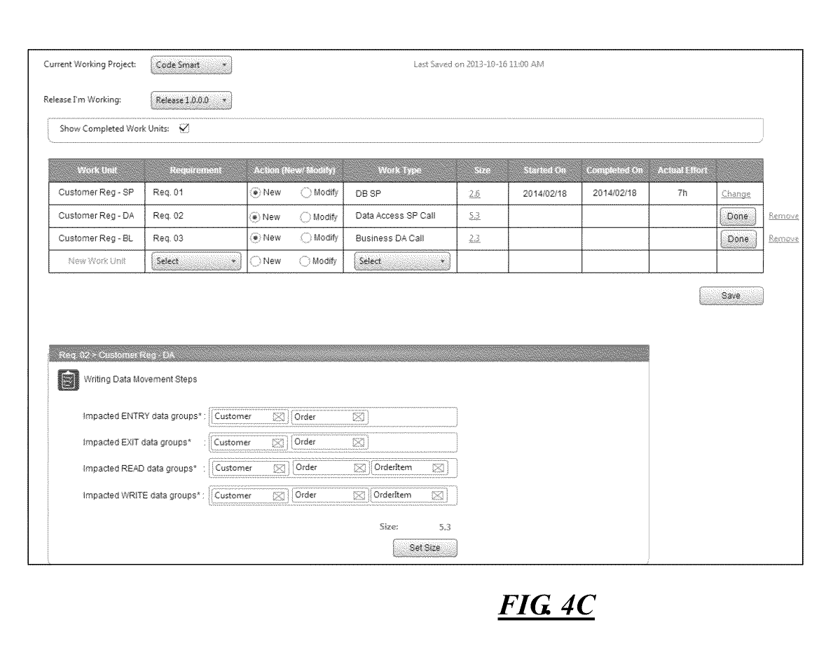

As depicted in FIGS. 2 and 3, once the work types have been defined (Step 100) and associated with sizing methods (Step 104), project requirements can then be decomposed into work items that are instances of the defined work types (FIG. 2) and each of the work items can be assigned to individuals for completion (Step 108; FIG. 3), typically by members of the software development team. As depicted in FIGS. 4A-4C, management and developers can size these granular work items using the sizing method associated with the work item's defined work type.

As they work on their assigned tasks, developers can update the status of the work items assigned to them as started or completed. When a developer marks a work item as completed, the developer also provides an estimate of the actual amount of effort spent on the work item, at which point that work item is credited to the developer.

Embodiments of the present invention collect the size and effort data specified in connection with completed work items and analyze the collected data (Step 112). For example, a regression line can be fit to the collected data by assuming that the data are a collection of ordered pairs of (size, effort) organized by work type and then fitting the ordered pairs to a parametric model (e.g., y=mx+c):

The collected data can be organized by work type and may also be organized according to additional parameters such as whether the work item involved original creative efforts or the modification of preexisting elements. The collected data may also be analyzed at various levels: the level of the individual developer performing the work task, the team of developers performing the work tasks, the organization to which the developers belong, etc. In other embodiments, depending on the collected data and the suitability of a linear fit, a regression fit can be performed using other polynomial forms.

Fitting a regression model to a work type allows for the calculation of expected effort for any work item of that work type having an arbitrary size (Step 116). Using the regression fit and the size of an individual's contribution computed using the sizing method associated with that work type, the expected effort associated with the contribution can be determined and used to award a credit (a/k/a “DevPoints”) to a developer based on the size of the completed task. These credits may be used to reward and/or further incentivize the developer's performance.

DevPoints are calculated based on the relative performance of the entire pool of developers doing tasks of the same work type and therefore provides a fair basis for comparison of developer productivity across different technologies and work stream. Furthermore, points collected for different work types can also be aggregated based on expected effort, thus providing an automatic normalization mechanism for different work types across developers.

Thus DevPoints, estimated effort, and the actual effort measures from developers provide a basis for calculating and comparing productivity across developers performing different work types. These measures can also be compared against the ratio of functional implementation effort to the total effort to identify or reduce manipulation or data issues.

Besides providing the ability to measure and motivate developers on a productivity improvement path, DevPoints also provides several interesting features. First, DevPoints can be used to estimate a developer's expected effort for a particular work task based on the developer's past history and provide an estimate of the developer's expected effort when the developer is sizing the work. The developer's expected effort can also be estimated using the models developed for the developer's organization and/or his team and show him how he is performing relative to those estimates, motivating the developer to perform better. When a developer completes a work item, his expended effort can be compared against the expected effort computed from his own historical effort data and receive an indication as to whether his efficiency is improving or getting worse, as well as providing the same comparison with respect to the other developers on his team, his team as a whole, and his organization as a whole. The developer's efforts can also be analyzed according to the work type of the tasks that he performs, helping the developer identify his relative strengths and weaknesses (e.g., strong in reports, weak in middle tier components) and guiding his training and professional development. Productivity factors can also be calculated dynamically for any randomly assembled team using the aggregation of the individual developers' past data.

The estimation and sizing model described so far is geared towards functional implementation and productivity motivation at an individual level. However, organizations also require early stage estimation models that can correlate work types from an end-user perspective to total release effort so that new work can be estimated accurately for commercial purposes. Applications typically involve multiple layers of implementation components. End-user work types are those that make sense from and end-user's perspective—in other words, work types that directly interact with the user or the application's data store/external systems. For example, in this categorization, middle-tier components in a Java application are not end-user work types, but reports and data tables are. By using this categorization, it is possible to calculate the size of end-user work types by release.

The foregoing describes a system that captures functional implementation effort. However, one of ordinary skill will recognize that total effort for the release, usually captured in other time-tracking systems, will contain other types of effort such as requirements, design, testing and project management. The implementation-to-release effort factor may be calculated as the ratio of total release effort to implementation effort recorded in the system. To generate an early stage estimation model, the system correlates size data for end-user work types and the total effort for those work types across the releases.

In some embodiments, the early stage sizing model may be simplified where the end-user work types may have a L, M, H, VH categorization with some ranges of inputs for each. For example, “User Interface Web Page” could be a work type that belongs to the functional sizing method with L being 1-5 data-movements, M being 6-10 data movements and so on. Such categorization can also be done automatically through the system by using the distribution of actual data points across many releases.

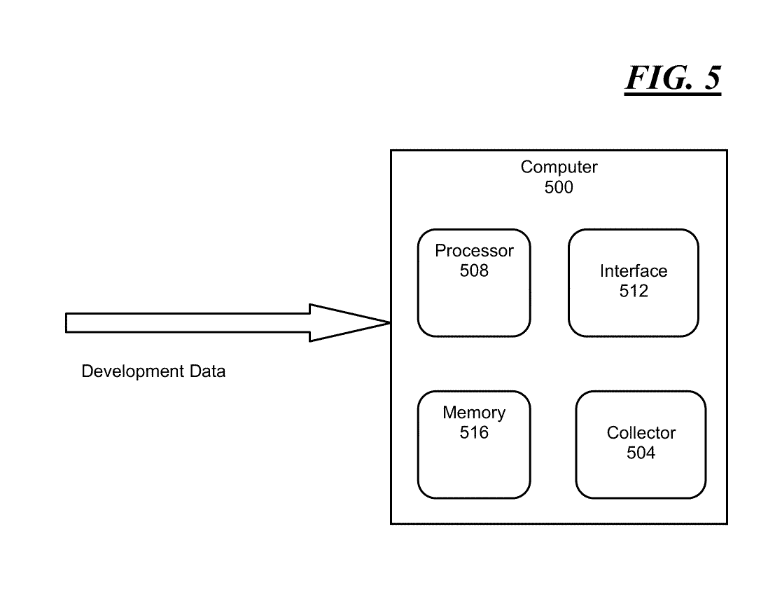

FIG. 5 presents an example of a system for managing developer productivity in accord with the present invention. The computer 500 may be a dedicated device such as a server or desktop computer containing one or more of the components depicted in FIG. 5; a general purpose device such as a tablet, phablet, etc., running a program that collects data concerning user activity as discussed herein; or a hosted service such as a cloud-based virtual machine executing one or more programs providing the functionality described above.

The collector 504 allows the system 500 to receive various forms of development data, including but not limited to sizing and effort data as discussed above, providing the data to the processor 508 for display via the interface 512 and/or storage in the memory 516. The collector 504 typically interacts with one or more assets or sources of asset usage data via a network interface such as gigabit Ethernet, Wi-Fi (802.11a/b/g/n), Bluetooth, and/or 3G/4G wireless interfaces such as GSM/WCDMA/LTE that enable data transmissions between system 500 and other devices and data sources.

The processor 508 is configured to analyze the development data received via the collector 504, generating various productivity measures one or more developers or groups of developers as discussed above. A typical processor 508 is an x86, x86-64, or ARMv7 processor, and the like.

The interface 512 allows the system 500 to receive commands from and/or provide feedback to a user; particular forms of feedback in accord with the present invention include various measures of developer productivity and efficiency. Exemplary interfaces 512 include graphical displays, physical keyboards, virtual keyboards, etc.

The memory 516 provides both transient and persistent storage for data received via the collector 504, data processed by the processor 508, and data received or sent via the interface 512. The memory 516 may, in various embodiments, be a hard drive, solid-state drive, a volatile memory, etc.

The description and illustration of one or more embodiments provided in this application are not intended to limit or restrict the scope of the present disclosure as claimed in any way. The embodiments, examples, and details provided in this application are considered sufficient to convey possession and enable others to make and use the best mode of the claimed embodiments. The claimed embodiments should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed embodiments.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein are not mutually exclusive and can exist in various combinations and permutations, even if such combinations or permutations were not discussed expressly herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Although the exemplary embodiments described implied the performance of steps in a specific order of operation, no required order should be ascribed to those embodiments. One of ordinary skill in the art will recognize that there are variations to those embodiments, including performing operations in a different order than described. Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

The description and illustration of one or more embodiments provided in this application are not intended to limit or restrict the scope of the present disclosure as claimed in any way. The embodiments, examples, and details provided in this application are considered sufficient to convey possession and enable others to make and use the best mode of the claimed embodiments. The claimed embodiments should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed embodiments.

What is claimed is:

1. A method for productivity measurement, the method comprising executing the following steps by at least one processor capable of executing instructions encoded on a computer-readable medium:
decomposing requirements into a plurality of tasks, each task selected from a group consisting of previously defined work types that are associated with an implementing technology;
assigning each of the plurality of tasks to an individual for execution;
collecting a size value and an effort value associated with the execution of each task; and
creating a parametric model from a plurality of size values and effort values.

2. The method of claim 1 further comprising utilizing the parametric model to create an estimated effort value for a task associated with the implementing technology associated with the parametric model.

3. The method of claim 1 wherein the requirements are associated with a plurality of implementing technologies.

4. The method of claim 1 further comprising associating each of the plurality of tasks with a sizing method.

5. The method of claim 4 wherein the sizing methods are selected from the group consisting of functionality, schema, and configuration.

6. The method of claim 4 wherein the sizing method is a continuous function.

7. The method of claim 1 wherein creating a parametric model comprises performing a regression fit to the parametric model.

8. The method of claim 1 wherein the plurality of size values and effort values used for the creation of the parametric model are associated with one of an individual developer, a plurality of developers, and a development organization.

9. The method of claim 1 further comprising computing expected effort utilizing the created parametric model.

10. The method of claim 1 further comprising evaluating performance utilizing the created parametric model.

11. A computer program product for enabling a computer to manage productivity, the product comprising a non-transitory computer readable medium and software instructions encoded on the non-transitory computer readable medium that when executed enable the computer to perform the operations of:
decomposing requirements into a plurality of tasks, each task selected from a group consisting of previously defined work types that are associated with an implementing technology;
assigning each of the plurality of tasks to an individual for execution;
collecting a size value and an effort value associated with the execution of each task; and
creating a parametric model from a plurality of size values and effort values.

12. The computer program product of claim 11 wherein the software instructions further comprise the operation of utilizing the parametric model to create an estimated effort value for a task associated with the implementing technology associated with the parametric model.

13. The computer program product of claim 11 wherein the requirements are associated with a plurality of implementing technologies.

14. The computer program product of claim 11 wherein the software instructions further comprise the operation of associating each of the plurality of tasks with a sizing method.

15. The computer program product of claim 14 wherein the sizing methods are selected from the group consisting of functionality, schema, and configuration.

16. The computer program product of claim 14 wherein the sizing method is a continuous function.

17. The computer program product of claim 11 wherein the software instructions for creating a parametric model comprise software instructions for performing a regression fit to the parametric model.

18. The computer program product of claim 11 wherein the plurality of size values and effort values used for the creation of the parametric model are associated with one of an individual developer, a plurality of developers, and a development organization.

19. The computer program product of claim 11 wherein the software instructions further comprise the operation of computing expected effort utilizing the created parametric model.

20. The computer program product of claim 11 wherein the software instructions further comprise the operation of evaluating performance utilizing the created parametric model.
